(19) United States
(12) Patent Application Publication
(10) Pub. No.: US 2011/0136005 A1
(43) Pub. Date: Jun. 9, 2011

(54) Vitamin B12 iron battery

(76) Inventor: Gregory Scott Callen, Anaheim, CA (US)

(21) Appl. No.: 12/592,880

(22) Filed: Dec. 4, 2009

(51) Int. Cl. H01M 10/0564; H01M 4/36

(52) U.S. Cl. 429/188; 429/122; 429/221

(57) ABSTRACT

A portable, rechargeable, and environmentally benign energy system, having an Iron Electrode (21) and a multitude of B12 molecules (41). The chemical energy is produced by the exchange of Cyanide Ions between Iron and Cobalt. The B12 molecules, having Cobalt atoms as part of their structure, provides an environmentally benign operation.

### BACKGROUND OF INVENTION

1. Field of Invention

The current invention generally relates to a portable and rechargeable energy storage release system, specifically to a Vitamin B12 Iron Secondary Battery.

2. Prior Art

Portable energy is necessary in modern life. We need mobile power for our cell phones, laptop computers, transportation, hearing aids, pacemakers, and emergency rescue devices. The future promises to be even more dependent on portable and rechargeable energy systems.

Also needing mention, is our dependance on petroleum. Gasoline, a petroleum derived resource, is currently the dominate transportation fuel. Due to the nature and wide use of the gasoline powered Internal Combustion Engine (ICE), copious amounts of sulfuric acid, nitric acid, carbon-dioxide, carbon-monoxide, and other contaminates . . . are increasing all over the world. If we continue to dump these chemical byproducts of gasoline and the ICE in ever increasing amounts, our planet will no longer support life.

The Lead Acid Battery's chief components, Lead (Pb) and Sulfuric Acid (H₂SO₄), are chemically harsh to most life on this planet. These chemicals need to be recycled when the life of the battery is over. Pb is heavy, having an Atomic Weight of 207; and yields a considerable penalty when used in a Battery Electric Vehicle (BEV). H₂SO₄, if splashed about in a traffic accident, can cause severe burns of the skin, ears, face, and eyes.

With Nickel-Cadmium Batteries, Cadmium (Cd) occurs in vary small quantities in ores such as Sphalerite and Greenockite. It would be necessary to scar the land with large open pit quarries, should Cadmium become a primary element for energy storage. Cadmium is toxic; making this type of battery's operation difficult to achieve in an environmentally benign way.

The Lithium-Ion Battery is expensive. Metallic Lithium (Li) currently costs $300 per pound. Li on its own is corrosive, and requires special handling. Lithium will ignite if combined with water. If Li becomes a common chemical on our roadways, emergency assistance may become more complicated.

Nickel-Metal Hydride (NiMH) battery cells have a lower volumetric energy density and a higher self-discharge rate as compared to Lithium-Ion Cells. Nickel-Metal-Hydride batteries when over-charged, create gases and heat. There is an inherent risk with NiMH chemistry; overcharging will buildup hydrogen gas, causing the cell to rupture (and/or) start a fire.

The Sony “Bio Battery” only generates 50 mW from a 39 mm on a side cube. Sony's Bio Battery technology requires a continuous supply of glucose to maintain an uninterrupted source of power. If this technology were to be employed on a global scale, the glucose needed for electrical power would likely result in higher cost for animal feed and at the grocery market.

### Objects and Advantages

The present invention, Vitamin B12 (B12) and Iron Battery, will enhance the public's safety by using atoms and chemistry found in living things and are common in nature and the environment. Iron (Fe) is a necessary constituent of hemoglobin and plays a roll in the transportation of oxygen in the body. B12 is the name for a class of chemically-related compounds involved in the metabolism of every cell in the body of nearly all animal life. The resulting chemistry of combining Iron and Cyanide, is Prussian Blue. Iron Cyanide is routinely used as the light sensitive dye for making blueprints.

This portable power supply will have a negligible environmental impact. Iron, as a common material in industry, has a proven history, is well understood, and appears to be safe. Biosynthesis of Vitamin B12 can be accomplished by bacteria in a process kin to brewing beer. There is no need to harvest B12 from the food supply, as what would be necessary with biodiesel and the Sony Bio Battery. The remaining constituents of this energy system are organic or inert substances like silicon or carbon.

The Vitamin B12 Rechargeable Battery will have a one time material cost. When the proper chemistry is installed into an enclosure, only electrons need to be exchanged for the discharge or recharging of the system.

### SUMMARY

All existing battery technologies have a large risk to the environment and also to the public's safety. There is a growing need for portable power, specifically in the transportation sector. A safe and abundant alternative to hydro-carbons and other dangerous chemistry is available here, in this document.

The scope, ramifications, and operation of the present invention, a Vitamin B12 and Iron Battery, will become more clear with a thorough inspection of the drawings and detailed description.

### DRAWINGS—FIGURES

FIG. 1: Conventional Battery Design

FIG. 2: Coiled Battery Design

FIG. 3: B12 Molecules

### REFERENCE NUMERALS

21: Iron Electrode

23: Chemically Inactive Electrode

25: Load, Power, or Meter

27: Separator

41: B12 Mixture

43: Deoxyadenosine

45: Prussian Blue

47: Predetermined Catalyzing Additive

60: Mixture of #41, #43, #45, #47

### DESCRIPTION

The typical configuration of a chemical battery is two dissimilar metals in an aqueous solution, providing an energy differential. In the present invention, one of the two metals is Iron. The second of the two metals is cobalt, in the form of a B12 molecule called specifically, Cyanocobalamin. The aqueous solution is comprised of Deoxyadenosine and a predetermined mixture or liquid, such as, an Oil, an Alcohol, or Glycerin; or the active chemistry shall be a dry powder.

Cyanocobalamin is commonly used as a Vitamin B12 Dietary Supplement. The reader is directed to notice Cyanide is in the prefix of this chemical. According the book, “Chemistry and Biochemistry of B12” Edited by Ruma Banerjee, states the Cyanide part of Cyanocobalamin is an artifact of the B12 purification process. A more natural form of the B12 molecule is Adenosylcobalamin, also known as, coenzyme cobalamin.

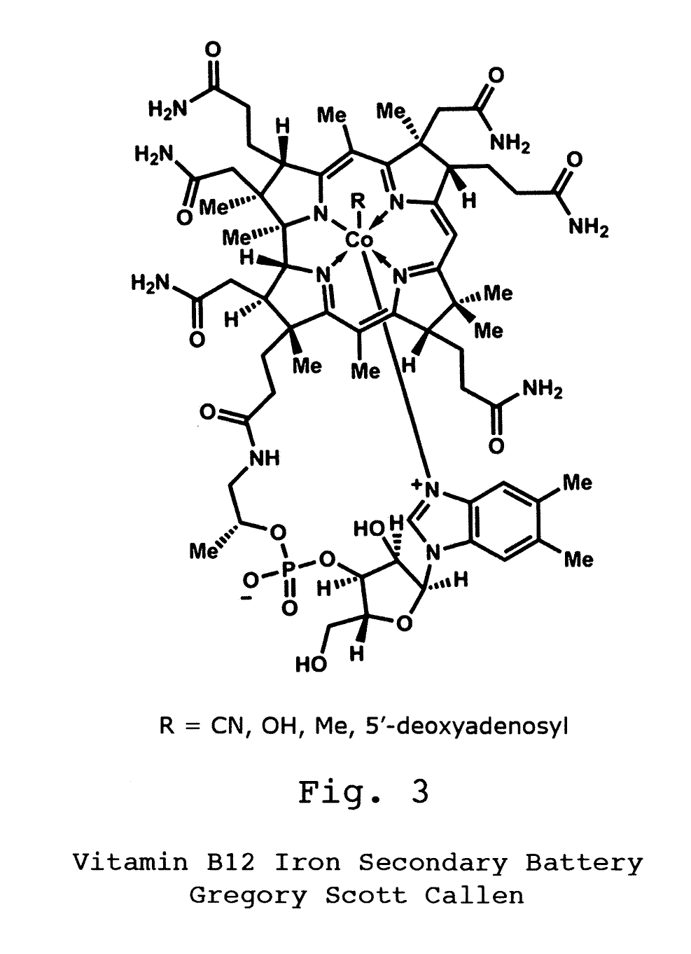

It is possible to freely exchange the chemical bonds of the cobalt atom within the B12 molecule. The cobalt atom, as part of B12, may bond with at least four different molecules, namely: Cyanide (CN), Hydroxide (OH), Methane (Me), and Deoxyadenosine, as shown in FIG. 3.

The key chemical principal within this battery's design is the exchange of cyanide between iron and cobalt. The involvement of B12 is to make the cyanide ion safe for the consumer and the natural world. To replace the bond between the B12 molecule and Cyanide, the natural coenzyme form of B12, containing Deoxyadenosine, is an excellent choice. Because Iron-Cyanide, also known as Prussian Blue, is insoluble in water; Glycerine seems to be a viable alternative to H₂O, and can become a source of Hydroxide (OH) ions.

The chemicals on the left energy side of the reaction of the present invention, are, Iron Cyanide and Adenosylcobalamin; on the right side of the chemical reaction, are Deoxyadenosine, Cyanocobalamin, and Iron.

Below is the intended chemical reaction in word and formula forms:

Iron-Cyanide+6*Adenosylcobalamin+6e [symbol] 6*Deoxyadenosine+6*Cyanocobalamin+Iron Fe(CN)₆+6(C₇₃H₁₀₁CoN₁₉O₁₇P)+6e− [symbol] 6(C₁₀H₁₃N₅O₃)+6(C₆₄H₈₈CoN₁₅O₁₄P)+Fe

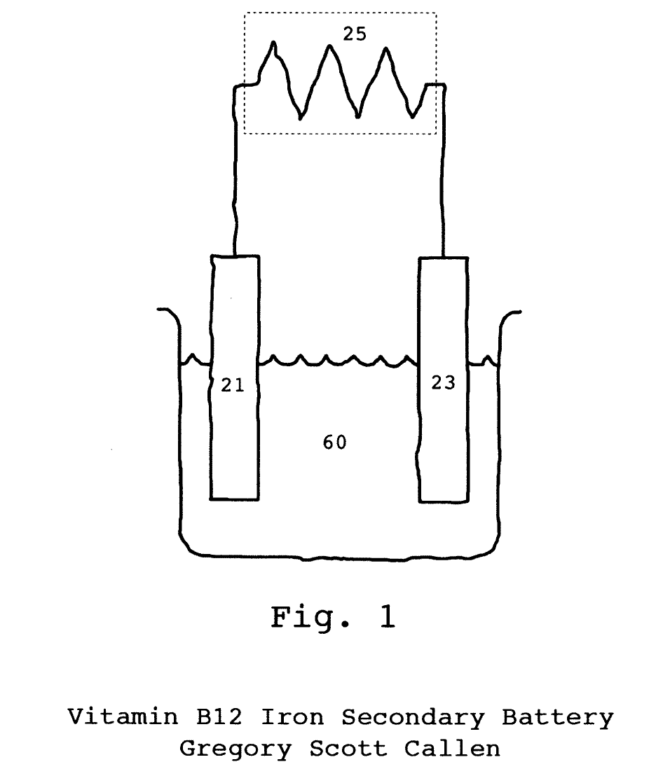

### First Embodiment—FIG. 1

In a single glass container, an iron electrode (21) and a ceramic electrode (23) are exposed to a electrolyte paste (60) containing Deoxyadenosine (43), Cyanocobalamin (41), and predetermined catalyzing additive (47). An energy differential is indicated by a volt meter (25).

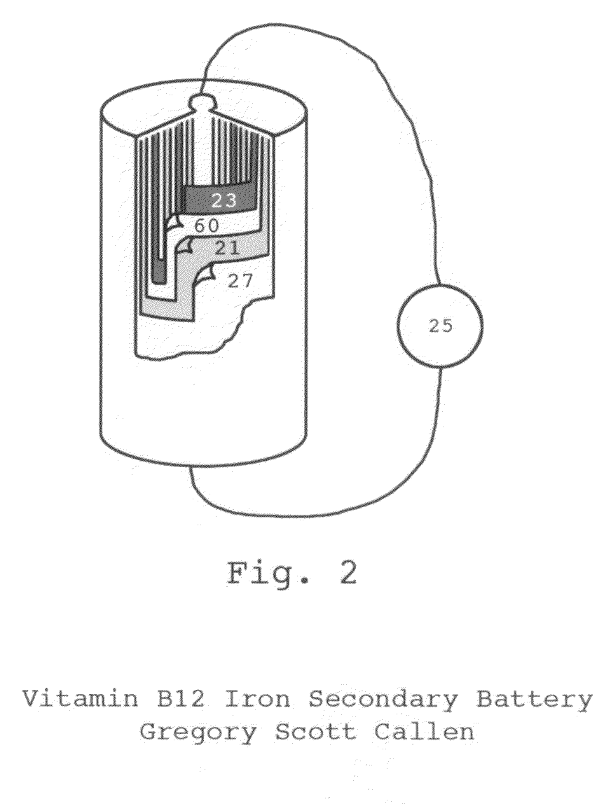

### Alternative Embodiment—FIG. 2

Sheets and foils are coiled and sandwiched into a predetermined form factor, iron (21), a B12 mixture (60), a conductive plastic film (23) and, insulation (27), are wound into a cylinder. An electrode is attached to the coil's iron foil (21) and to the opposite end of the coil, an electrode is attached to the conductive plastic film (23), having the electrical potential between the electrodes, turn a motor (25).

### Operation

A ceramic, plastic, or glass coated enclosure, surrounds the proper chemistry; Deoxyadenosine, Cyanocobalamin, and an Iron Electrode. An electrical load, an electrical power source, and a volt meter may be connected to the electrodes. Only electrons need be exchanged; providing an environmentally benign operation. The Vitamin B12 and Iron battery will charge and discharge multiple times before the battery needs replacing.

### Ramifications

Cobalt is available at a modest price, Iron is incredibly plentiful, and organic chemistry is abundant and can grow exponentially, making all the materials needed for this battery trivial to obtain. There are no emissions and no additional materials needed. The only cost to the consumer beyond the initial cost of the battery is for the energy.

### Scope

While the above description contains many specificities, these should not be construed as limitations on the scope of any embodiment, but as exemplifications of the presently preferred embodiments thereof. Many other ramifications and variations are possible within the teachings of the various embodiments. For example, a series of cells, similar to the Lead Acid Battery having Iron instead of Lead and having B12 instead of H₂SO₄. Thus the scope of the invention should be determined by the appended claims and their legal equivalents, and not by the examples given.

I claim:

1. A chemical energy storage release system, comprising:
a. a multitude of iron atoms,
b. a multitude of cyanide ions and,
c. a multitude of cobalt atoms,
wherein said energy storage release system,
having an energy differential,
providing means for producing electrical energy.

2. The chemical energy storage release system of claim 1 wherein,
said multitude of cobalt atoms,
having a corresponding multitude of b12 molecules,
providing means for an environmentally benign operation.

3. The chemical energy storage release system of claim 2 wherein,
said multitude of b12 molecules,
including a predetermined additive,
providing means for catalyzing said energy differential.

4. The chemical energy storage release system of claim 1 wherein,
said iron atoms, said cobalt atoms and, said cyanide ions
having a sandwich coil form factor,
providing means for a predetermined rate of chemical activity.

5. A battery, comprising:
a. an iron electrode,
b. a mixture containing b12 molecules and,
c. a non-reactive electrode,
wherein said battery providing means for producing electrical power.

6. The battery of claim 5 wherein said mixture containing b12 molecules having deoxyadenosine.

7. The battery of claim 5 wherein said mixture containing b12 molecules having a predetermined oil.

8. The battery of claim 5 wherein said mixture containing b12 molecules having a predetermined alcohol.

9. The battery of claim 5 wherein said mixture containing b12 molecules having glycerin.
